(19) United States
(12) Patent Application Publication
(10) Pub. No.: US 2026/0299983 A1
(43) Pub. Date: Oct. 1, 2026

(54) LIVE MIGRATION METHOD FOR VIRTUAL MACHINE, AND DEVICE, AND SYSTEM, AND STORAGE MEDIUM

(71) Applicant: CLOUD INTELLIGENCE ASSETS HOLDING (SINGAPORE) PRIVATE LIMITED, Singapore (SG)

(72) Inventor: Dianchen TIAN, Hangzhou, Zhejiang (CN)

(21) Appl. No.: 18/879,965

(22) PCT Filed: Aug. 23, 2023
(86) PCT No.: PCT/CN2023/114506

§ 371 Date: Dec. 30, 2024

(30) Foreign Application Priority Data
Aug. 26, 2022 (CN) 202211035631.8

(51) Int. Cl. G06F 9/455

(52) U.S. Cl. CPC G06F 9/45558; G06F 2009/4557

(57) ABSTRACT

Embodiments of the present application provide a live migration method for a virtual machine, and a device, and a system, and a storage medium. An optimization solution is proposed for the traditional live migration architecture, a source host machine is configured with an acceleration device, so that on the side of the source host machine, the live migration work of a control plane and a data plane can be fully assigned to the acceleration device for execution, and the live migration work can be completed simply by means of a cooperation between a destination host machine and the acceleration device, which enables the live migration work to allow for zero dependence on resources of the source host machine.

### CROSS-REFERENCE TO RELATED APPLICATIONS

The present application is a National Stage of International Application No. PCT/CN2023/114506, filed on Aug. 23, 2023, which claims priority to Chinese Patent Application No. 202211035631.8, filed on Aug. 26, 2022 to the China National Intellectual Property Administration and entitled “LIVE MIGRATION METHOD FOR VIRTUAL MACHINE, AND DEVICE, AND SYSTEM, AND STORAGE MEDIUM”. These applications are incorporated herein by reference in their entireties.

### TECHNICAL FIELD

The present application relates to the field of cloud computing technology and, in particular, to a live migration method for a virtual machine, and a device, and a system, and a storage medium.

### BACKGROUND

In a public cloud, there are many large-scale virtual machines, this kind of virtual machines have been a challenge for live migration in the industry due to their high configuration and heavy load, which is mainly reflected in the following two points.
1. The memory is large and a dirty page rate is particularly high. In typical networks, it is difficult to achieve iterative convergence for live migration.
2. There are many instances carried on physical CPU (Central Processing Unit) resources, especially when the instances have already fully-occupied the entire machine, and there is no spare physical CPU resource left for the live migration.

However, at present, all live migration methods in the industry require consumption of CPU resources for live migration work in an operating environment of the virtual machines, which forces the live migration to share physical CPU resources with a VCPU (Virtual CPU). On the one hand, this may cause duty jitter in virtual machines, and on the other hand, result in poor migration performance due to insufficient computing resources for the live migration.

### SUMMARY

Several aspects of the present application provide a live migration method for a virtual machine, and a device, and a system and a storage medium, aimed at improving the resource occupancy problem of a source host machine during live migration of virtual machines.

An embodiment of the present application provides a live migration system for a virtual machine, including: a source host machine, a first acceleration device corresponding to the source host machine, and a destination host machine;
where the first acceleration device is configured to: read dirty page information from the source host machine during a live migration process; look up source address information of a to-be-transmitted dirty page of a current round based on the dirty page information; and send the source address information to the destination host machine;
the destination host machine is configured to: acquire the source address information; initiate a dirty page read request based on the source address information; and utilize the first acceleration device to acquire the to-be-transmitted dirty page of the current round from the source host machine.

An embodiment of the present application further provides a live migration method for a virtual machine, applied to a first acceleration device configured for a source host machine, the method includes:
reading dirty page information from the source host machine during a live migration process;
looking up source address information of a to-be-transmitted dirty page of a current round based on the dirty page information;
sending the source address information to a destination host machine, for the destination host machine to initiate a dirty page read request based on the source address information;
reading the to-be-transmitted dirty page of the current round from the source host machine; and
providing the read to-be-transmitted dirty page of the current round to the destination host machine, to respond to the dirty page read request.

An embodiment of the present application further provides a live migration method for a virtual machine, applied to a second acceleration device configured for a destination host machine, where the method includes:
receiving source address information of a to-be-transmitted dirty page of a current round during a live migration process, where the to-be-transmitted dirty page of the current round is provided by a first acceleration device configured for a source host machine;
providing the source address information to the destination host machine;
utilizing the first acceleration device to read the to-be-transmitted dirty page of the current round from the source host machine, according to a dirty page read request initiated by the destination host machine based on the source address information; and
writing, into the destination host machine, the to-be-transmitted dirty page of the current round acquired.

An embodiment of the present application further provides an acceleration device, connected with a source host machine, including a dirty page iteration component and a communication component;
where the dirty page iteration component is configured to: read, through the communication component, dirty page information from the source host machine during a live migration process; look up source address information of a to-be-transmitted dirty page of a current round based on the dirty page information; and send the source address information to a destination host machine, for the destination host machine to initiate a dirty page read request based on the source address information; and
the communication component is configured to: read the to-be-transmitted dirty page of the current round from the source host machine; send the read to-be-transmitted dirty page of the current round to the destination host machine, to respond to the dirty page read request.

An embodiment of the present application further provides an acceleration device, connected with a destination host machine, including a dirty page iteration component and a communication component;
where the dirty page iteration component is configured to: receive source address information of a to-be-transmitted dirty page of a current round during a live migration process, the to-be-transmitted dirty page of the current round being provided by a first acceleration device configured for a source host machine; and provide the source address information to the destination host machine; and
the communication component is configured to: utilize the first acceleration device to read the to-be-transmitted dirty page of the current round from the source host machine, according to a dirty page read request initiated by the destination host machine based on the source address information; and write, into the destination host machine, the to-be-transmitted dirty page of the current round acquired.

An embodiment of the present application further provides a computer-readable storage medium storing computer instructions, when the computer instructions are executed by one or more processors, the one or more processors are caused to perform the aforementioned live migration method for a virtual machine.

In embodiments of the present application, there are acceleration devices corresponding to a source host machine and a destination host machine respectively. On the side of the source host machine, the acceleration device on the source host machine reads dirty page information from the source host machine during a live migration process; looks up source address information of a to-be-transmitted dirty page of a current round based on the dirty page information; and sends the source address information to the side of the destination host machine. And on the side of the destination host machine, it can acquire the source address information; initiate a dirty page read request based on the source address information, and utilize the acceleration device on the side of the source host machine to read the to-be-transmitted dirty page of the current round from the source host machine. Based on this, an optimization solution for the traditional live migration architecture is provided in the embodiments of the present application. By configuring the acceleration device on the side of the source host machine, the live migration work of a control plane and a data plane on the side of the source host machine can be fully assigned to the acceleration device for execution. The live migration work can be completed simply by means of a cooperation between the destination host machine and the acceleration device, which enables the live migration work to allow for zero dependence on the resources of the source host machine. Even under a circumstance that computing resources of the source host machine are fully occupied, the performance of live migration will not be affected, and the live migration function achieves zero jitter for a virtual machine running on the source host machine.

### BRIEF DESCRIPTION OF DRAWINGS

The drawings described herein are used to provide further understanding of the present application and constitute a part of the present application. The illustrative embodiments of the present application and the descriptions thereof are used to explain the present application and do not constitute undue limitation of the present application. In the drawings:

FIG. 1a is a schematic structure diagram of a live migration system for a virtual machine provided by an exemplary embodiment of the present application;

FIG. 1b is a schematic structure diagram of another live migration system for a virtual machine provided by an exemplary embodiment of the present application;

FIG. 2 is a schematic diagram of a hardware implementation of an acceleration device provided by an exemplary embodiment of the present application;

FIG. 3 is a schematic flowchart of a live migration method for a virtual machine provided by another exemplary embodiment of the present application;

FIG. 4 is a schematic flowchart of another live migration method for a virtual machine provided by another exemplary embodiment of the present application;

FIG. 5 is a schematic structure diagram of an acceleration device provided by a further exemplary embodiment of the present application; and

FIG. 6 is a schematic structure diagram of another acceleration device provided by a further exemplary embodiment of the present application.

### DESCRIPTION OF EMBODIMENTS

In order to make the purpose, technical solution, and advantages of the present application clearer, the following will provide a clear and comprehensive description of the technical solution of the present application in conjunction with specific embodiments and corresponding drawings of the present application. Obviously, the described embodiments are a part of the embodiments of the present application, not all of them. Based on the embodiments of the present application, all other embodiments obtained by those of ordinary skill in the art without any creative effort are within the protection scope of the present application.

At present, live migration work of a virtual machine needs to occupy resources of a source host machine, which causes poor migration efficiency and potentially causes duty jitter of the virtual machine. Therefore, in some embodiments of the present application: there are acceleration devices corresponding to a source host machine and a destination host machine respectively. On the side of the source host machine, the acceleration device on the source host machine reads dirty page information from the source host machine during a live migration process; looks up source address information of a to-be-transmitted dirty page of a current round based on the dirty page information; and sends the source address information to the side of the destination host machine. And on the side of the destination host machine, it can acquire the source address information; initiate a dirty page read request based on the source address information, and utilize the acceleration device on the side of the source host machine to read the to-be-transmitted dirty page of the current round from the source host machine. Based on this, an optimization solution for the traditional live migration architecture is provided in the embodiments of the present application. By configuring the acceleration device on the side of the source host machine, the live migration work of a control plane and a data plane on the side of the source host machine can be fully assigned to the acceleration device for execution. The live migration work can be completed simply by means of a cooperation between the destination host machine and the acceleration device, which enables the live migration work to allow for zero dependence on the resources of the source host machine. Even under a circumstance that computing resources of the source host machine are fully occupied, the performance of live migration will not be affected, and the live migration function achieves zero jitter for a virtual machine running on the source host machine.

The following provides a detailed explanation of the technical solutions provided by respective embodiments of the present application, in conjunction with the drawings.

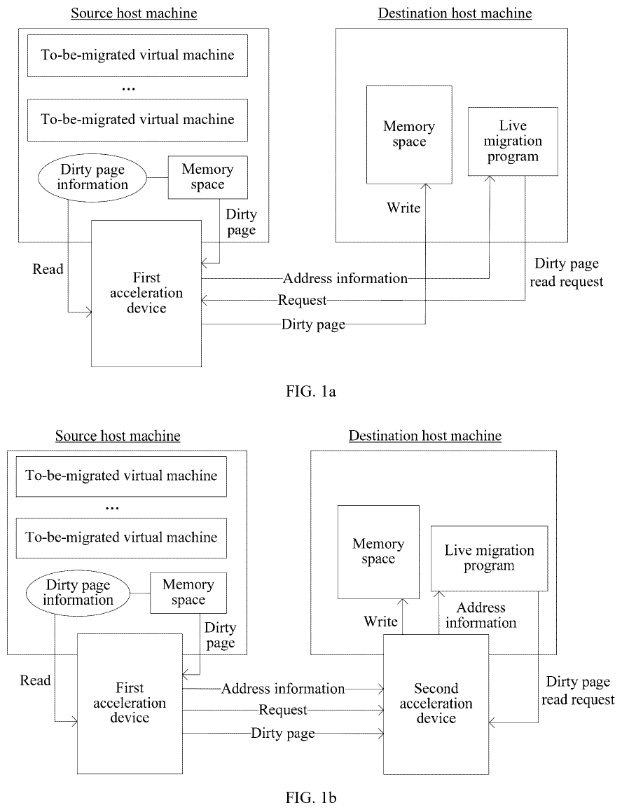

FIG. 1a is a schematic structure diagram of a live migration system for a virtual machine provided by an exemplary embodiment of the present application. As shown in FIG. 1a, the system includes: a source host machine, a first acceleration device corresponding to the source host machine, and a destination host machine.

In the live migration system for the virtual machine according to this embodiment, the traditional pre-copy live migration solution is inherited and improved. The pre-copy live migration solution is as follows: the source host machine sends memory data to the destination host machine through iteration, all memory data is sent in a first round of the iteration; a dirty page in a pre-copy process of a previous round is sent in each following round; a last round is a stop-and-copy stage, where the source host machine is suspended, updating of the memory is stopped, and the dirty pages are copied as a whole to the destination host machine. The live migration system for the virtual machine according to this embodiment improves both a dirty page iteration process and a dirty page transmission process.

In this embodiment, the source host machine refers to a host machine where a virtual machine that needs to be migrated is located, the destination host machine is a host machine to which the virtual machine that needs to be migrated is going to be migrated.

As mentioned in previous texts, in the pre-copy live migration solution, multiple rounds of migration are required. For ease of description, this embodiment will explain the technical solution from the perspective of one round of migration process. It should be understood that the same technical solution can be used to achieve migration in each round of migration process. What is special is the first round of migration process in the pre-copy live migration solution. In the first round of migration process, all memory pages in the dirty page information can be considered as dirty pages without performing a dirty page look-up operation. Based on this, all memory data in the source host machine can be migrated to the destination host machine according to the technical solution provided by this embodiment.

Refer to FIG. 1a, in this embodiment, the first acceleration device configured for the source host machine can read the dirty page information from the source host machine during a live migration process. The dirty page information can be used to store a label indicating whether several memory pages allocated for the virtual machine are dirty pages. The first acceleration device can be externally connected to the source host machine, or, of course, integrated into the source host machine, this embodiment does not limit the actual connection manner between the two sides. In an implementation, a dirty page bitmap can be used as the dirty page information, and the dirty page bitmap may be a binary sequence. It should be understood that in this embodiment, the dirty page information can also use other forms of information, which is not limited to the dirty page bitmap. For example, if 512 KB of memory is allocated to a virtual machine and each memory page is 4 KB in size, then the number of memory pages is 512/4=128. Therefore, the virtual machine corresponds to a dirty page bitmap including 128 bits, where each bit represents whether a memory page is a dirty page; if a first bit of the dirty page bitmap is 1, it represents that a first memory page is a dirty page; if a second bit of the dirty page bitmap is 0, it represents that a second memory page is not a dirty page. It is worth noting that in this embodiment, the dirty page bitmap is already present on the source host machine and can usually be maintained by a KVM (Kernel-based Virtual Machine, Kernel-based Virtual Machine) on the source host machine.

Based on this, in this embodiment, the dirty page iteration process (i.e., work of a control plane) in the pre-copy live migration solution can be fully assigned to the first acceleration device for execution. Therefore, for the first acceleration device, the source address information of the to-be-transmitted dirty page in the current round can be looked up based on the dirty page information. In this embodiment, the first acceleration device can traverse the dirty page information, that is, scan the dirty page information bit by bit, to discover the source address information of the dirty page. The source address information is used to represent the location(s) of the dirty page(s) in the memory space of the source host machine. Here, the dirty page iteration process will be completely decoupled from the source host machine, with zero dependence on the resources in the source host machine, that is to say, this process does not occupy any CPU resources in the source host machine.

Refer to FIG. 1a, the first acceleration device can send the source address information of the to-be-transmitted dirty page of the current round to the destination host machine.

In this embodiment, the destination host machine may have a customized live migration program running therein, and since there are a large amount of idle resources in the destination host machine before the live migration is completed, in this embodiment, the idle resources on the destination host machine can be used to support the running of the live migration program. For example, CPU resources on the destination host machine will usually be reserved for a to-be-migrated virtual machine; in this embodiment, the live migration program can use the CPU resources on the destination host machine that are designated for a migrated virtual machine, to support the running of the live migration program. It should be understood that before the migration of the virtual machine is completed, the CPU resources designated for the migrated virtual machine are idle and available. Of course, this is only exemplary, in this embodiment, other idle resources on the destination host machine can also be used to support the running of the live migration program thereon, which is not limited in this embodiment.

The destination host machine can cooperate with the first acceleration device based on the customized live migration program running thereon, to implement the dirty page transmission process in the pre-copy live migration solution (i.e., work of a data plane). The destination host machine can initiate a dirty page read request based on the acquired source address information, under the driving of the customized live migration program thereon. Since the architecture where the source host machine actively pushes dirty pages in the traditional solution has been changed in this embodiment, the destination host machine can here further carry, in the dirty page read request, destination address information allocated on the destination host machine for the to-be-transmitted dirty page of the current round, so that the dirty page can be written to a correct location in the memory space of the destination host machine after being read back. During the live migration process, addresses allocated for memory data on the source host machine generally correspond one by one to addresses reserved for the memory data on the destination host machine, therefore, the destination host machine can easily and quickly find a destination address corresponding to a dirty page based on this corresponding relationship under the situation that the source address information is received, and carry the destination address in the dirty page read request.

FIG. 1b is a schematic structure diagram of another live migration system for a virtual machine provided by an exemplary embodiment of the present application. Refer to FIG. 1b, in an implementation for this embodiment, a second acceleration device may also be configured on the side of the destination host machine. Based on this, the destination host machine also cooperates with the first acceleration device and the second acceleration device, to implement the dirty page transmission process in the pre-copy live migration (i.e., the work of the data plane).

Refer to FIG. 1b, on the basis of adding the second acceleration device, the first acceleration device can send the source address information of the to-be-transmitted dirty page to the second acceleration device. For the second acceleration device, it can provide the received source address information to the destination host machine and trigger the destination host machine to generate the dirty page read request. The destination host machine can send the dirty page read request to the second acceleration device corresponding to the destination host machine. Referring to FIG. 1b, for the second acceleration device, it can utilize the first acceleration device to read the to-be-transmitted dirty page of the current round from the source host machine, according to the dirty page read request initiated by the destination host machine. That is, the first acceleration device and the second acceleration device can cooperate with each other to respond to the dirty page read request initiated by the destination host machine. Due to the connection between the first acceleration device and the source host machine, after reading the to-be-transmitted dirty page of the current round from the source host machine, the first acceleration device can return the to-be-transmitted dirty page of the current round to the second acceleration device. It should be noted that in this embodiment, there is no need to limit an order for reading dirty pages in a process that the first acceleration device and the second acceleration device cooperate with each other to read the to-be-transmitted dirty page of the current round.

In an implementation for this embodiment, the first acceleration device can read the to-be-transmitted dirty page of the current round from the source host machine, according to a direct memory access DMA (direct memory access, direct memory access) manner; and provide the read to-be-transmitted dirty page of the current round to the second acceleration device. The DMA manner can support the first acceleration device to smoothly read the to-be-transmitted dirty pate of the current round from the source host machine, without dependence on the CPU resources in the source host machine. In this way, the dirty page transmission process will be also completely decoupled from the source host machine, with zero dependence on the resources in the source host machine, that is to say, this process does not occupy any CPU resources in the source host machine.

From this, it can be known that in this embodiment, all the work of the control plane and the data plane during the live migration process is decoupled from the source host machine, and is fully assigned to the first acceleration device configured for the source host machine to be executed. Therefore, there is no need to perform any task related to live migration on the source host machine, and no CPU resource needs to be invested for this, truly achieving zero dependence on the resources of the source host machine.

With continued reference to FIG. 1a, the first acceleration device can provide the to-be-transmitted dirty page of the current round to the destination host machine after reading the to-be-transmitted dirty page of the current round from the source host machine. Based on the system architecture shown in FIG. 1b, in this embodiment, the first acceleration device can transmit the to-be-transmitted dirty page of the current round back to the second acceleration device; the second acceleration device can write the acquired to-be-transmitted dirty page of the current round into the destination host machine. In an implementation for this embodiment, the second acceleration device can write the to-be-transmitted dirty page of the current round into the destination host machine according to the direct memory access DMA manner. As mentioned in previous texts, the dirty page read request initiated by the destination host machine carries the destination address information of the dirty page on the destination host machine, therefore, the second acceleration device can here write the received to-be-transmitted dirty page of the current round into a corresponding address in the destination host machine according to the destination address information in the dirty page read request. In this way, after issuing the dirty page read request, the destination host machine can receive the to-be-transmitted dirty page of the current round written by the second acceleration device corresponding to the destination host machine, thereby completing the migration of the dirty page of the current round.

As can be seen, the CPU of the source host machine does not participate in the entire dirty page transmission process at all, only the CPU of the destination host machine and the first acceleration device (in an exemplary solution, there is also a second acceleration device) participate in completion of the dirty page transmission. Therefore, on the one hand, zero consumption of CPU resources on the source host machine is achieved, and a virtual machine running on the source host machine will not experience service jitter resulting from CPU resource competition; on the other hand, the performance of dirty page transmission is not limited by the CPU resources of the source host machine. By transferring dirty pages through idle CPUs of the destination host machine and the acceleration devices on either sides, the performance of dirty page transmission can be maintained at the peak in terms of hardware, ensuring the performance of dirty page transmission.

Based on this, in this embodiment, there are acceleration devices corresponding to a source host machine and a destination host machine respectively. On the side of the source host machine, the acceleration device on the source host machine reads dirty page information from the source host machine during a live migration process; looks up source address information of a to-be-transmitted dirty page of a current round based on the dirty page information; and sends the source address information to the side of the destination host machine. And on the side of the destination host machine, it can acquire the source address information; initiate a dirty page read request based on the source address information, and utilize the acceleration device on the side of the source host machine to read the to-be-transmitted dirty page of the current round from the source host machine. Based on this, an optimization solution for the traditional live migration architecture is provided in the embodiments of the present application. By configuring the acceleration device on the side of the source host machine, the live migration work of a control plane and a data plane on the side of the source host machine can be fully assigned to the acceleration device for execution. The live migration work can be completed simply by means of a cooperation between the destination host machine and the acceleration device, which enables the live migration work to allow for zero dependence on the resources of the source host machine, and effectively improves the efficiency of live migration work.

In the embodiments described above or below, a remote direct memory access RDMA manner can be used to achieve the assignment of the dirty page transmission process.

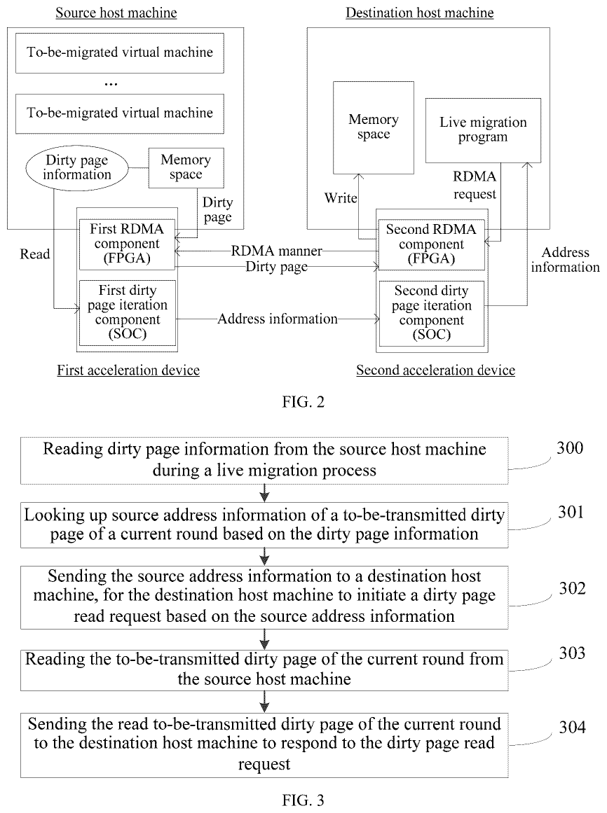

In this embodiment, the destination host machine can generate a remote direct memory access RDMA instruction as the dirty page read request, according to destination address information allocated on the destination host machine for the to-be-transmitted dirty page of the current round and the source address information; and under the situation that the destination host machine is configured with the second acceleration device, the destination host machine can send the RDMA instruction to the second acceleration device. Correspondingly, for the second acceleration device, it can utilize the first acceleration device to read the to-be-transmitted dirty page of the current round from the source host machine, according to the remote direct memory access RDMA manner. Of course, under the situation that the destination host machine is not configured with the second acceleration device, the destination host machine can also utilize the first acceleration device to read the to-be-transmitted dirty page of the current round from the source host machine, autonomously according to the remote direct memory access RDMA manner. FIG. 2 is a schematic diagram of a hardware implementation of an acceleration device provided by an exemplary embodiment of the present application. Refer to FIG. 2, in terms of hardware implementation, in order to support the implementation of the dirty page transmission process according to the RDMA manner, in this embodiment, the first acceleration device may include a first RDMA component, and the second acceleration device may include a second RDMA component. The RDMA components are provided with RDMA communication capabilities. In an implementation for this embodiment, programmable devices such as FPGAs (Field Programmable Gate Arrays) can be used to simulate the RDMA components, or RDMA network cards can also be used as the RDMA components, or other ASIC-based (Application Specific Integrated Circuit) devices with RDMA capabilities can be used as the RDMA components. The hardware implementation of the RDMA components is not limited in this embodiment. Especially the FPGAs, due to possession of dedicated integrated circuits, they are particularly suitable for the work characteristic of intensive computation but simple logic in the dirty page transmission progress according to this embodiment. The RDMA components simulated by the FPGAs can excellently complete the data transmission and reception work in the dirty page transmission process. Of course, the hardware implementation of these kinds of RDMA components mentioned here are only exemplary, and this embodiment is not limited thereto.

Based on this, in an exemplary solution of dirty page transmission: for the second RDMA component, it can store, into a transmission queue, an RDMA instruction issued by the destination host machine for a respective to-be-transmitted dirty page of the current round; and encapsulate the respective RDMA instruction into an RDMA read packet, then send the respective RDMA read packet to a reception queue maintained in the first RDMA component; for the first RDMA component, it can parse source address information of a related dirty page from the RDMA read packet in the reception queue, and encapsulate, into an RDMA reply packet, the related dirty page read from the source host machine according to the source address information, then send the RDMA reply packet to the second RDMA component, specifically, it can send the RDMA reply packet to a reply queue maintained by the second RDMA component. In this way, the first RDMA component can assist the second RDMA component in reading the to-be-transmitted dirty page of the current round from the source host machine according to the remote direct memory access RDMA manner.

In an implementation, considering that in the pre-copy live migration solution, it is necessary to ensure the integrity and orderliness of dirty page migration of each round, therefore, in this exemplary solution, the second RDMA component can further maintain a completion queue, the second RDMA component can maintain, in the completion queue, completion status of the to-be-transmitted dirty page of the current round. For the destination host machine, a completion queue for the to-be-transmitted dirty page of the current round can be created in advance in the second RDMA component; the second RDMA component can fill in a completion identifier corresponding to a corresponding dirty page into the completion queue after the transmission of any dirty page is completed in this queue. In this way, the destination host machine can perceive the completion status of each dirty page in the completion queue in a pulling manner. After all the dirty pages in the completion queue have gotten the completion identifiers, the destination host machine can confirm that the transmission of all the to-be-transmitted dirty pages of the current round is completed and can start a next round of migration. It should be understood that other manners can be used between the destination host machine and the second RDMA component to synchronize whether a transmission of all the to-be-transmitted dirty pages of the current round have been completed. For example, the second RDMA component can generate a notification event after each completion of the transmission of one dirty page and provide the notification event to the destination host machine, so that the destination host machine can perceive which dirty pages have been transmitted and can autonomously judge whether the transmission of all the to-be-transmitted dirty pages of the current round have been completed, etc., which is not limited in this embodiment.

In this exemplary solution, the first RDMA component and the second RDMA component can maintain their respective relevant queues according to an RDMA standard protocol and exchange relevant packets, to respond to an RDMA instruction initiated by the destination host machine according to the RDMA manner. Of course, this is not limited in this embodiment, and the first RDMA component and the second RDMA component can also respond to an RDMA request initiated by the destination host machine according to other self-defining transmission protocols. That is, interaction details between the first RDMA component and the second RDMA component are not limited to the exemplary solution described above, and will not be elaborated here.

Moreover, in this embodiment, in addition to the RDMA components, the first acceleration device may also include a first dirty page iteration component, and the second acceleration device may also include a second dirty page iteration component. In an implementation for this embodiment, the dirty page iteration components may be implemented using system level SOC (System on chip) chips or dedicated host machines. The SOC chip can be known as a system on chip, which is a product that is an integrated circuit with a dedicated purpose, and which includes a complete system and includes embedded software in entirety; therefore, the SOC chip is particularly suitable for the work characteristic of complex logic but less computation in the dirty page iteration process according to this embodiment, the SOC chip can excellently complete the traverse work of the dirty page information during the dirty page iteration process. And for the situation that the dedicated host machine is used to implement the dirty page iteration component, a plurality of source host machines can share a same dedicated host machine, the dedicated host machine can provide function support of dirty page iteration for different source host machines. For example, the dedicated host machine can run different dirty page iteration processes for different source host machines, to isolate the dirty page iteration work corresponding to different source host machines. For the working logic of each dirty page iteration process, reference can be made to the description of the dirty page iteration process by the first acceleration device in the previous text, which will not be repeated here.

Based on this, in this embodiment, the first dirty page iteration component can be responsible for operations of reading the dirty page information from the source host machine during the live migration process, looking up the source address information of the to-be-transmitted dirty page of the current round based on the dirty page information, and sending the source address information to the second acceleration device; the second dirty page iteration component is responsible for an operation of providing the source address information to the destination host machine.

It is worth noting that for the situation where hardware forms such as SOC chips and dedicated host machines are used to implement the dirty page iteration components, the aforementioned RDMA components can be used as a hardware bridge between the dirty page iteration components and the source/destination host machines. In this way, the first dirty page iteration component can use the first RDMA component as a hardware bridge (such as an FPGA channel) to read the dirty page information from the source host machine, and the second RDMA component can also be used as a hardware bridge between the second dirty page iteration component and the destination host machine to transmit the address information of the to-be-transmitted dirty page of the current round, etc. Of course, this is only exemplary and this embodiment is not limited to thereto.

Based on this, in this embodiment, an acceleration device can include an RDMA component and a dirty page iteration component, the dirty page iteration component can be used for assignment of the dirty page iteration process, and the RDMA component can be used for assignment of the dirty page transmission process.

In this embodiment, in addition to using the aforementioned remote direct memory access RDMA manner to achieve assignment of the dirty page transmission process, other communication manners can also be used to achieve assignment of the dirty page transmission process. For example, a TCP (Transmission Control Protocol) manner can be used to implement the dirty page transmission process. Under the TCP manner, the acceleration devices can be implemented using SOC chips or dedicated host machines. In this example, the RDMA components no longer need to be configured in the acceleration devices; instead, the SOC chip or dedicated host machine corresponding to the source host machine can directly read the dirty page information and the to-be-transmitted dirty page of the current round from the source host machine through the DMA manner or other manners. The acceleration devices on either sides can interact with each other through a TCP protocol, and the SOC chip or dedicated host machine externally connected to the destination host machine can receive the dirty page read request from the destination host machine or write the to-be-transmitted dirty page of the current round into the destination host machine directly through the DMA manner or other manners. This embodiment does not limit the communication manner used in the dirty page transmission process. For different communication manners, appropriate hardware forms can be used to implement the acceleration devices.

Based on this, in this embodiment, communication manners such as RDMA can be used to implement the dirty page transmission process during the live migration for the virtual machine. Throughout the entire process, there is no need for the source host machine to participate in, ensuring zero dependence on the source host machine. And the dirty page transmission process can be completed unilaterally on the destination host machine, achieving a pre-copy live migration effect similar to post-copy. That is, the work that originally needs to be executed in the source host machine is transferred to the destination host machine for execution, which can achieve zero occupation of the resources of the source host machine. On the one hand, it can eliminate a jitter problem of the virtual machine caused by live migration, and on the other hand, it can free the performance of live migration from the constraints of CPU resources in the source host machine, thereby stabilizing the high performance of live migration.

FIG. 3 is a schematic flowchart of a live migration method for a virtual machine provided by another exemplary embodiment of the present application. The method can be executed by an acceleration apparatus, the acceleration apparatus may be implemented as a combination of software and/or hardware. The acceleration apparatus can be integrated in a first acceleration device configured for a source host machine. Refer to FIG. 3, the method includes:
a step 300, reading dirty page information from the source host machine during a live migration process;
a step 301, looking up source address information of a to-be-transmitted dirty page of a current round based on the dirty page information;
a step 302, sending the source address information to a destination host machine, for the destination host machine to initiate a dirty page read request based on the source address information;
a step 303, reading the to-be-transmitted dirty page of the current round from the source host machine; and
a step 304, sending the read to-be-transmitted dirty page of the current round to the destination host machine to respond to the dirty page read request.

In an implementation, the destination host machine is configured with a second acceleration device, the step 302 includes:
sending the source address information to the second acceleration device configured for the destination host machine, for the second acceleration device to trigger the destination host machine to initiate the dirty page read request based on the source address information;
the step 304 includes: sending the read to-be-transmitted dirty page of the current round to the second acceleration device, to cooperate with the second acceleration device to respond to the dirty page read request.

In an implementation, the step 303 may include:
reading the to-be-transmitted dirty page of the current round from the source host machine according to a direct memory access DMA manner.

In an implementation, the destination host machine can generate a remote direct memory access RDMA instruction as the dirty page read request, according to destination address information allocated on the destination host machine for the to-be-transmitted dirty page of the current round and the source address information; and send the RDMA instruction to the second acceleration device;
the step of sending the read to-be-transmitted dirty page of the current round to the second acceleration device may include: sending the read to-be-transmitted dirty page of the current round to the second acceleration device, according to a remote direct memory access RDMA manner.

In an implementation, the first acceleration device includes a first RDMA component, the second acceleration device includes a second RDMA component; the method specifically includes:
storing an RDMA read packet sent by the second RDMA component in a reception queue, where the RDMA read packet is generated by the second RDMA component by encapsulating a respective RDMA instruction after storing the RDMA instruction issued by the destination host machine for a respective to-be-transmitted dirty page of the current round into a transmission queue;
parsing source address information of a related dirty page from the RDMA read packet in the reception queue; and
encapsulating, into an RDMA reply packet, the related dirty page read from the source host machine according to the source address information, then sending the RDMA reply packet to the second RDMA component, to assist the second RDMA component in reading the to-be-transmitted dirty page of the current round from the source host machine according to the remote direct memory access RDMA manner.

In an implementation, the first RDMA component and the second RDMA component are implemented using FPGAs, RDMA network cards, or other ASIC-based devices with RDMA capabilities.

In an implementation, the first acceleration device further includes a first dirty page iteration component, the second acceleration device further includes a second dirty page iteration component; the first dirty page iteration component is responsible for the steps 300-302

In an implementation, the first dirty page iteration component and the second dirty page iteration component are implemented using system level SOC chips or dedicated host machines.

In an implementation, the first acceleration device and the second acceleration device are implemented using SOC chips or dedicated host machines; the first acceleration device and the second acceleration device read the to-be-transmitted dirty page of the current round from the source host machine according to a TCP protocol.

It is worth noting that reference can be made to the relevant descriptions of the first acceleration device in the aforementioned system embodiments for technical details in various embodiments of the migration method for the virtual machine as mentioned above. To save article length, these technical details will not be repeated here, but this should not result in a loss of the protection scope of the present application.

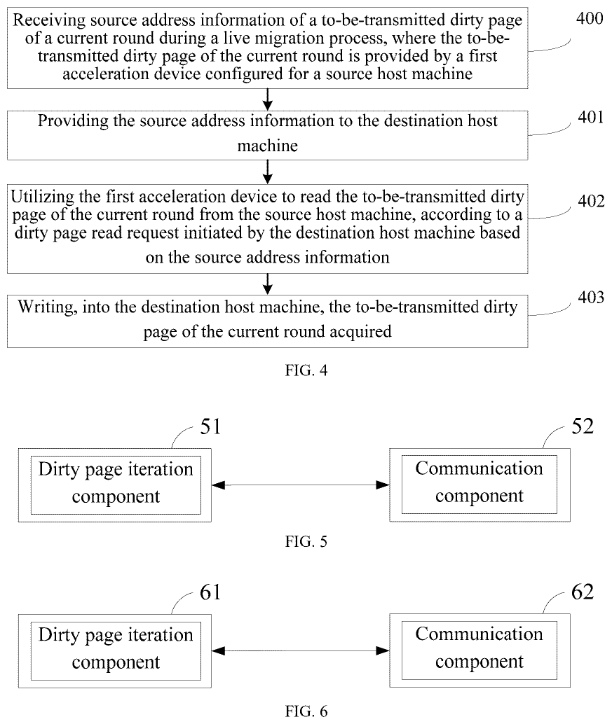

FIG. 4 is a schematic flowchart of another live migration method for a virtual machine provided by another exemplary embodiment of the present application. The method can be executed by an acceleration apparatus, the acceleration apparatus may be implemented as a combination of software and/or hardware. The acceleration apparatus can be integrated in a second acceleration device configured for a destination host machine. Refer to FIG. 4, the method includes:
a step 400, receiving source address information of a to-be-transmitted dirty page of a current round during a live migration process, where the to-be-transmitted dirty page of the current round is provided by a first acceleration device configured for a source host machine;
a step 401, providing the source address information to the destination host machine;
a step 402, utilizing the first acceleration device to read the to-be-transmitted dirty page of the current round from the source host machine, according to a dirty page read request initiated by the destination host machine based on the source address information;
a step 403, writing, into the destination host machine, the to-be-transmitted dirty page of the current round acquired.

In an implementation, the step 403 includes: writing the to-be-transmitted dirty page of the current round into the destination host machine, according to a direct memory access DMA manner.

In an implementation, the destination host machine can generate a remote direct memory access RDMA instruction as the dirty page read request, according to destination address information allocated on the destination host machine for the to-be-transmitted dirty page of the current round and the source address information; and send the RDMA instruction to the second acceleration device; the step 402 may include:
utilizing the first acceleration device to read the to-be-transmitted dirty page of the current round from the source host machine, according to a remote direct memory access RDMA manner.

In an implementation, the first acceleration device includes a first RDMA component, the second acceleration device includes a second RDMA component; the method specifically includes:
storing an RDMA instruction issued by the destination host machine for a respective to-be-transmitted dirty page of the current round into a transmission queue; and encapsulating the respective RDMA instruction into an RDMA read packet, then sending the respective RDMA read packet to a reception queue maintained in the first RDMA component, for the first RDMA component to parse source address information of a related dirty page from the RDMA read packet in the reception queue, and encapsulate, into an RDMA reply packet, the related dirty page read from the source host machine according to the source address information, then send the RDMA reply packet to the second RDMA component.

In an implementation, the method further includes: maintaining, in a completion queue, completion status of the to-be-transmitted dirty page of the current round, for the destination host machine to start a next round of migration following a determination according to the completion status of the to-be-transmitted dirty page of the current round in the completion queue that migration of all to-be-transmitted dirty pages of the current round is completed.

In an implementation, the first RDMA component and the second RDMA component are implemented using FPGAs, RDMA network cards, or other ASIC-based devices with RDMA capabilities.

In an implementation, the first acceleration device further includes a first dirty page iteration component, the second acceleration device further includes a second dirty page iteration component; the second dirty page iteration component is responsible for an operation of providing the source address information to the destination host machine.

In an implementation, the first dirty page iteration component and the second dirty page iteration component are implemented using system level SOC chips or dedicated host machines.

In an implementation, the first acceleration device and the second acceleration device are implemented using SOC chips or dedicated host machines, the first acceleration device and the second acceleration device read the to-be-transmitted dirty page of the current round from the source host machine according to a TCP protocol.

It is worth noting that reference can be made to the relevant descriptions of the second acceleration device in the aforementioned system embodiments for technical details in various embodiments of the migration method for the virtual machine as mentioned above. To save article length, these technical details will not be repeated here, but this should not result in a loss of the protection scope of the present application.

In addition, some processes described in the embodiments and drawings described above include multiple operations appeared in a specific order. However, it should be clearly understood that these operations may not be executed in an order they appear herein or in parallel. The operation numbers, such as 801, 802, etc., are only used to distinguish different operations and do not represent any execution order. Moreover, these processes can include more or fewer operations, and these operations can be executed in an order or in parallel. It should be noted that descriptions “first”, “second”, etc. herein are used to distinguish different devices, components, etc., do not represent an order or do not limit “first” and “second” being different types.

FIG. 5 is a schematic structure diagram of an acceleration device provided by a further exemplary embodiment of the present application. This acceleration device can be connected with a source host machine. As shown in FIG. 5, this acceleration device includes: a dirty page iteration component 51 and a communication component 52;
where the dirty page iteration component 51 is configured to: read, through the communication component 52, dirty page information from the source host machine during a live migration process; look up source address information of a to-be-transmitted dirty page of a current round based on the dirty page information; and send the source address information to a destination host machine, for the destination host machine to initiate a dirty page read request based on the source address information; and
the communication component 52 is configured to: read the to-be-transmitted dirty page of the current round from the source host machine; send the read to-be-transmitted dirty page of the current round to the destination host machine, to respond to the dirty page read request.

In an implementation, the destination host machine is configured with a second acceleration device, the dirty page iteration component 51, during a process of sending the source address information to the destination host machine, can be configured to:
send the source address information to the second acceleration device configured for the destination host machine, for the second acceleration device to trigger the destination host machine to initiate the dirty page read request based on the source address information;
the communication component 52, during a process of sending the read to-be-transmitted dirty page of the current round to the destination host machine, can be configured to: send the read to-be-transmitted dirty page of the current round to the second acceleration device, to cooperate with the second acceleration device to respond to the dirty page read request.

In an implementation, the communication component 52, during a process of reading the to-be-transmitted dirty page of the current round from the source host machine, can be configured to:
read the to-be-transmitted dirty page of the current round from the source host machine according to a direct memory access DMA manner.

In an implementation, the destination host machine can generate a remote direct memory access RDMA instruction as the dirty page read request, according to destination address information allocated on the destination host machine for the to-be-transmitted dirty page of the current round and the source address information; and send the RDMA instruction to the second acceleration device;
the communication component 52, during a process of sending the read to-be-transmitted dirty page of the current round to the second acceleration device, can be configured to: send the read to-be-transmitted dirty page of the current round to the second acceleration device, according to a remote direct memory access RDMA manner.

In an implementation, the communication component 52 may include a first RDMA component, the second acceleration device may include a second RDMA component; the first RDMA component can be configured to:
store an RDMA read packet sent by the second RDMA component in a reception queue, where the RDMA read packet is generated by the second RDMA component by storing the RDMA instruction issued by the destination host machine for a respective to-be-transmitted dirty page of the current round into a transmission queue and encapsulating the respective RDMA instruction;
parse source address information of a related dirty page from the RDMA read packet in the reception queue; and
encapsulate, into an RDMA reply packet, the related dirty page read from the source host machine according to the source address information, then send the RDMA reply packet to the second RDMA component, to assist the second RDMA component in reading the to-be-transmitted dirty page of the current round from the source host machine according to the remote direct memory access RDMA manner.

In an implementation, the first RDMA component and the second RDMA component are implemented using FPGAs, RDMA network cards, or other ASIC-based devices with RDMA capabilities.

In an implementation, the dirty page iteration component in this acceleration device and the second dirty page iteration component in the second acceleration device connected with the destination host machine are implemented using system level SOC chips or dedicated host machines.

In an implementation, this acceleration device and the second acceleration device are implemented using SOC chips or dedicated host machines, this acceleration device and the second acceleration device read the to-be-transmitted dirty page of the current round from the source host machine according to a TCP protocol.

Furthermore, this acceleration device further includes: other components such as a power component 53.

It is worth noting that reference can be made to the relevant descriptions of the first acceleration device in the aforementioned system embodiments for technical details in various embodiments of the acceleration device as mentioned above. To save article length, these technical details will not be repeated here, but this should not result in a loss of the protection scope of the present application.

FIG. 6 is a schematic structure diagram of another acceleration device provided by a further exemplary embodiment of the present application. This acceleration device can be connected with a destination host machine. As shown in FIG. 6, this acceleration device includes: a dirty page iteration component 61 and a communication component 62;
where the dirty page iteration component 61 is configured to: receive source address information of a to-be-transmitted dirty page of a current round during a live migration process, the to-be-transmitted dirty page of the current round being provided by a first acceleration device configured for a source host machine; and provide the source address information to the destination host machine; and
the communication component 62 is configured to: utilize the first acceleration device to read the to-be-transmitted dirty page of the current round from the source host machine, according to a dirty page read request initiated by the destination host machine based on the source address information; and write, into the destination host machine, the to-be-transmitted dirty page of the current round acquired.

In an implementation, the communication component 62, during a process of writing the acquired to-be-transmitted dirty page of the current round into the destination host machine, can be configured to: write the to-be-transmitted dirty page of the current round into the destination host machine, according to a direct memory access DMA manner.

In an implementation, the destination host machine can generate a remote direct memory access RDMA instruction as the dirty page read request, according to destination address information allocated on the destination host machine for the to-be-transmitted dirty page of the current round and the source address information; and send the RDMA instruction to this acceleration device; the communication component 62, during a process of utilizing the first acceleration device to read the to-be-transmitted dirty page of the current round from the source host machine, can be configured to:
utilize the first acceleration device to read the to-be-transmitted dirty page of the current round from the source host machine, according to a remote direct memory access RDMA manner.

In an implementation, the first acceleration device includes a first RDMA component, the communication component 62 includes a second RDMA component; the second RDMA component can be configured to:
store an RDMA instruction issued by the destination host machine for a respective to-be-transmitted dirty page of the current round into a transmission queue; and encapsulate the respective RDMA instruction into an RDMA read packet, then send the respective RDMA read packet to a reception queue maintained in the first RDMA component; for the first RDMA component to parse source address information of a related dirty page from the RDMA read packet in the reception queue, and encapsulate, into an RDMA reply packet, the related dirty page read from the source host machine according to the source address information, then send the RDMA reply packet to the second RDMA component.

In an implementation, the dirty page iteration component 61 can be further configured to: maintain, in a completion queue, completion status of the to-be-transmitted dirty page of the current round, for the destination host machine to start a next round of migration following a determination according to the completion status of the to-be-transmitted dirty page of the current round in the completion queue that migration of all to-be-transmitted dirty pages of the current round is completed.

In an implementation, the first RDMA component and the second RDMA component are implemented using FPGAs, RDMA network cards, or other ASIC-based devices with RDMA capabilities.

In an implementation, the first dirty page iteration component in the first acceleration device on the source host machine and the dirty page iteration component 61 in this acceleration device are implemented using system level SOC chips or dedicated host machines.

In an implementation, the first acceleration device and this acceleration device are implemented using SOC chips or dedicated host machines, the first acceleration device and this acceleration device read the to-be-transmitted dirty page of the current round from the source host machine according to a TCP protocol.

Furthermore, this acceleration device further includes: other components such as a power component 63.

It is worth noting that reference can be made to the relevant descriptions of the second acceleration device in the aforementioned system embodiments for technical details in various embodiments of the acceleration device as mentioned above. To save article length, these technical details will not be repeated here, but this should not result in a loss of the protection scope of the present application.

Correspondingly, an embodiment of the present application further provides a computer-readable storage medium storing a computer program, when the computer program is executed, the steps that can be executed by the first acceleration device or the second acceleration device in the method embodiments described above can be implemented.

Those skilled in the art should understand that the embodiments of the present application can be provided as methods, systems, or computer program products. Therefore, the present application may take a form of a fully hardware implementation, a fully software implementation, or an implementation with a combination in terms of software and hardware. Moreover, the present application may take a form of a computer program product implemented on one or more computer usable storage media (including but not limited to a disk storage, a CD-ROM, an optical storage, etc.) including computer usable program codes.

The present application is described with reference to a flowchart and/or a block diagram of the method, device (system), and computer program product according to the embodiments of the present application. It should be understood that each process and/or block in the flowchart and/or the block diagram, as well as a combination of processes and/or blocks in the flowchart and/or the block diagram, can be implemented by computer program instructions. These computer program instructions can be provided to a processor of a general-purpose computer, a dedicated computer, an embedded processor, or other programmable data processing device to produce a machine, such that the instructions executed by the processor of the computer or other programmable data processing device generate an apparatus for implementing the functions specified in one or more processes in the flowchart and/or one or more blocks in the block diagram.

These computer program instructions can also be stored in a computer-readable memory that can guide a computer or other programmable data processing device to operate in a specific manner, causing instructions stored in the computer-readable memory to produce a manufactured product including an instruction apparatus, the instruction apparatus implements a function specified in one or more processes in a flowchart or and/or in one or more blocks in a block diagram.

These computer program instructions can also be loaded onto a computer or other programmable data processing device, causing a series of operational steps to be executed on the computer or other programmable device to produce computer implemented processing. The instructions executed on the computer or other programmable device provide the steps for implementing the function specified in one or more processes in a flowchart or and/or in one or more blocks in a block diagram.

In a typical configuration, a computing device includes one or more processors (CPUs), input/output interfaces, network interfaces, and memories.

A memory may include a non-permanent storage, a random access memory (RAM), and/or a non-volatile memory, and similar forms in a computer-readable medium, such as a read only memory (ROM) or a flash RAM (flash RAM). The memory is an example of a computer-readable medium.

The computer-readable medium, including a permanent and non-permanent medium, a removable and non-removable medium, can be used by any method or technology to achieve information storage. Information can be computer-readable instructions, data structures, modules of programs, or other data. Examples of a storage medium for a computer include, but are not limited to: a phase change memory (PCM), a static random access memory (SRAM), a dynamic random access memory (DRAM), and other types of random access memory (RAM), a read-only memory (ROM), an electrically erasable programmable read-only memory (EEPROM), a flash memory or other memory technologies, a read-only optical disc read-only memory (CD-ROM), a digital versatile disc (DVD) or other optical storage, disk-type tapes, magnetic tape storage or other magnetic storage devices, or any other non-transmission medium, capable of being used to store information accessible by a computing device. According to the definition herein, the computer-readable medium does not include transitory computer-readable media (transitory media), such as modulated data signals and carriers.

It should also be noted that the terms “including”, “containing” or any other variation thereof are intended to encompass non-exclusive inclusion, such that a process, method, commodity or device that includes a series of elements not only includes those elements, but also includes other elements not explicitly listed, or also includes elements inherent to such process, method, commodity or device. Without further limitations, an element defined by the statement “including a . . . ” does not exclude the existence of other identical elements in the process, method, product, or device that includes the element described above.

The above description is only embodiments of the present application and is not intended to limit the present application. For those skilled in the art, the present application may have various modifications and variations. Any modifications, equivalent substitutions, improvements, etc. made within the spirit and principles of the present application shall be included within the protection scope of the present application.

What is claimed is:

1. A live migration system for a virtual machine, comprising: a source host machine, a first acceleration device corresponding to the source host machine, and a destination host machine;
wherein the first acceleration device is configured to: read dirty page information from the source host machine during a live migration process; look up source address information of a to-be-transmitted dirty page of a current round based on the dirty page information; and send the source address information to the destination host machine;
the destination host machine is configured to: acquire the source address information; initiate a dirty page read request based on the source address information; and utilize the first acceleration device to acquire the to-be-transmitted dirty page of the current round from the source host machine.

2. The system according to claim 1, wherein the destination host machine is provided with a second acceleration device correspondingly; the first acceleration device, during a process of sending the source address information to the destination host machine, is configured to:
send the source address information to the second acceleration device configured for the destination host machine;
the second acceleration device is configured to:
provide the source address information to the destination host machine;
utilize the first acceleration device to read the to-be-transmitted dirty page of the current round from the source host machine, according to the dirty page read request; and
write the acquired to-be-transmitted dirty page of the current round into the destination host machine.

3. The system according to claim 2, wherein the first acceleration device is further configured to: read the to-be-transmitted dirty pate of the current round from the source host machine, according to a direct memory access DMA manner; and provide the read to-be-transmitted dirty pate of the current round to the second acceleration device;
the second acceleration device, during a process of writing the acquired to-be-transmitted dirty page of the current round into the destination host machine, is configured to: write the to-be-transmitted dirty page of the current round into the destination host machine, according to the direct memory access DMA manner.

4. The system according to claim 2, wherein the destination host machine is configured to: generate a remote direct memory access RDMA instruction as the dirty page read request, according to destination address information allocated on the destination host machine for the to-be-transmitted dirty page of the current round and the source address information; and send the RDMA instruction to the second acceleration device;
the second acceleration device, during a process of utilizing the first acceleration device to read the to-be-transmitted dirty page of the current round from the source host machine, is configured to: utilize the first acceleration device to read the to-be-transmitted dirty page of the current round from the source host machine, according to a remote direct memory access RDMA manner.

5. The system according to claim 4, wherein the first acceleration device comprises a first RDMA component, the second acceleration device comprises a second RDMA component;
the second RDMA component is configured to: store an RDMA instruction issued by the destination host machine for a respective to-be-transmitted dirty page of the current round into a transmission queue; and encapsulate the respective RDMA instruction into an RDMA read packet, then send the respective RDMA read packet to a reception queue maintained in the first RDMA component;
the first RDMA component is configured to: parse source address information of a related dirty page from the RDMA read packet in the reception queue; and encapsulate, into an RDMA reply packet, the related dirty page read from the source host machine according to the source address information, then send the RDMA reply packet to the second RDMA component, to assist the second RDMA component in reading the to-be-transmitted dirty page of the current round from the source host machine according to the remote direct memory access RDMA manner.

6. The system according to claim 5, wherein the second RDMA component is further configured to maintain, in a completion queue, completion status of the to-be-transmitted dirty page of the current round;
the destination host machine is further configured to start a next round of migration following a determination according to the completion status of the to-be-transmitted dirty page of the current round in the completion queue that migration of all to-be-transmitted dirty pages of the current round is completed.

7. The system according to claim 5, wherein the first RDMA component and the second RDMA component are implemented using FPGAs, RDMA network cards, or other ASIC-based devices with RDMA capabilities.

8. The system according to claim 5, wherein the first acceleration device further comprises a first dirty page iteration component, the second acceleration device further comprises a second dirty page iteration component; the first dirty page iteration component is responsible for operations of reading the dirty page information from the source host machine during the live migration process, looking up the source address information of the to-be-transmitted dirty page of the current round based on the dirty page information, and sending the source address information to the second acceleration device;
the second dirty page iteration component is responsible for an operation of providing the source address information to the destination host machine.

9. The system according to claim 8, wherein the first dirty page iteration component and the second dirty page iteration component are implemented using system level SOC chips or dedicated host machines.

10. The system according to claim 1, wherein the destination host machine has a live migration program running thereon, and the live migration program uses CPU resources on the destination host machine which are designated for a migrated virtual machine, to execute an operation of initiating the dirty page read request based on the source address information.

11. The system according to claim 2, wherein the first acceleration device and the second acceleration device are implemented using SOC chips or dedicated host machines, the first acceleration device and the second acceleration device read the to-be-transmitted dirty page of the current round from the source host machine according to a TCP protocol.

12. A live migration method for a virtual machine, applied to a first acceleration device corresponding to a source host machine, the method comprising:
reading dirty page information from the source host machine during a live migration process;
looking up source address information of a to-be-transmitted dirty page of a current round based on the dirty page information;
sending the source address information to a destination host machine, for the destination host machine to initiate a dirty page read request based on the source address information;
reading the to-be-transmitted dirty page of the current round from the source host machine; and
providing the read to-be-transmitted dirty page of the current round to the destination host machine, to respond to the dirty page read request.

13. A live migration method for a virtual machine, applied to a second acceleration device configured for a destination host machine, the method comprising:
receiving source address information of a to-be-transmitted dirty page of a current round during a live migration process, wherein the to-be-transmitted dirty page of the current round is provided by a first acceleration device configured for a source host machine;
providing the source address information to the destination host machine;
utilizing the first acceleration device to read the to-be-transmitted dirty page of the current round from the source host machine, according to a dirty page read request initiated by the destination host machine based on the source address information; and
writing, into the destination host machine, the to-be-transmitted dirty page of the current round acquired.

14. (canceled)

15. (canceled)

16. A non-transitory computer-readable storage medium storing computer instructions, wherein when the computer instructions are executed by one or more processors, the one or more processors are caused to perform the live migration method for the virtual machine according to claim 12.

17. A non-transitory computer-readable storage medium storing computer instructions, wherein when the computer instructions are executed by one or more processors, the one or more processors are caused to perform the live migration method for the virtual machine according to claim 13.

18. The method according to claim 12, wherein the sending the source address information to a destination host machine, for the destination host machine to initiate a dirty page read request based on the source address information comprises: sending the source address information to a second acceleration device configured for the destination host machine, for the second acceleration device to trigger the destination host machine to initiate the dirty page read request based on the source address information; and
the providing the read to-be-transmitted dirty page of the current round to the destination host machine, to respond to the dirty page read request comprises: sending the read to-be-transmitted dirty page of the current round to the second acceleration device, to cooperate with the second acceleration device to respond to the dirty page read request.

19. The method according to claim 12, wherein the reading the to-be-transmitted dirty page of the current round from the source host machine comprises:
reading the to-be-transmitted dirty page of the current round from the source host machine according to a direct memory access DMA manner.

20. The method according to claim 18, wherein the destination host machine generates a remote direct memory access RDMA instruction as the dirty page read request, according to destination address information allocated on the destination host machine for the to-be-transmitted dirty page of the current round and the source address information; and sends the RDMA instruction to the second acceleration device;
the sending the read to-be-transmitted dirty page of the current round to the second acceleration device comprises: sending the read to-be-transmitted dirty page of the current round to the second acceleration device, according to a remote direct memory access RDMA manner.

21. The method according to claim 13, wherein the writing, into the destination host machine, the to-be-transmitted dirty page of the current round acquired comprises:
writing the to-be-transmitted dirty page of the current round into the destination host machine, according to a direct memory access DMA manner.

22. The method according to claim 13, wherein the destination host machine generates a remote direct memory access RDMA instruction as the dirty page read request, according to destination address information allocated on the destination host machine for the to-be-transmitted dirty page of the current round and the source address information; and sends the RDMA instruction to the second acceleration device;
the utilizing the first acceleration device to read the to-be-transmitted dirty page of the current round from the source host machine, according to a dirty page read request initiated by the destination host machine based on the source address information comprises: utilizing the first acceleration device to read the to-be-transmitted dirty page of the current round from the source host machine, according to a remote direct memory access RDMA manner.
